(19) United States
(12) Patent Application Publication
(10) Pub. No.: US 2025/0097204 A1
(43) Pub. Date: Mar. 20, 2025

(54) SECURING DATA COMMUNICATIONS WITH GENERATIVE PROTOCOLS

(71) Applicant: Cisco Technology, Inc., San Jose, CA (US)

(72) Inventors: Joel Abraham Obstfeld, Bushey (GB); Ronnie I. Dan, Modiin (IL); Louis Gwyn Samuel, Gloucestershire (GB)

(21) Appl. No.: 18/368,743

(22) Filed: Sep. 15, 2023

(51) Int. Cl. H04L 9/40; H04L 69/08

(52) U.S. Cl. CPC H04L 63/0435; H04L 63/20; H04L 69/08

(57) ABSTRACT

In one implementation, a device receives a request to generate a new communication protocol. The device generates, based on the request, the new communication protocol using a generative model. The device configures software to use the new communication protocol. The device causes an endpoint in a network to communicate using the new communication protocol via the software.

### TECHNICAL FIELD

The present disclosure relates generally to securing data communications with generative protocols.

### BACKGROUND

Entities wishing to compromise data communications between parties are, to some extent, helped by the use of data communications protocols that are based on published standards. Published standards provide an ‘information foothold’ that an entity can leverage. For instance, the Internet today is premised on the use of the Internet Protocol (IP) v4 (or IPv6) at its foundation, with Internet communications often secured using protocols such as Secure Sockets Layer (SSL), Transport Layer Security (TLS), or Internet Protocol Security (IPsec).

However, the public availability of these published standards for these protocols also means that any communications that use these protocols conform to predictable structures and formats. This presents a starting point that allows a malicious entity to analyze any intercepted communications and gain insights into the protocols, data formats, and encryption methods that it uses, which the malicious entity can then potentially exploit. The advent of quantum computing has also given rise to fears that existing encryption methods and techniques will be much more rapidly and easily compromised, as well.

Further security risks can also stem from the use of older protocol standards that did not consider newer attack methods, as well as flaws in standards implementations that create weaknesses that can be exploited. The impact can be significant when flaws are identified in commonly used secure communications methods, potentially affecting every user and device on the Internet.

### BRIEF DESCRIPTION OF THE DRAWINGS

The implementations herein may be better understood by referring to the following description in conjunction with the accompanying drawings in which like reference numerals indicate identically or functionally similar elements, of which:

FIGS. 1A-1B illustrate an example communication network;

FIG. 2 illustrates an example network device/node;

FIG. 3 illustrates an example architecture for securing data communications with generative protocols;

FIG. 4 illustrates an example of endpoints in a network communicating using a custom communication protocol;

FIG. 5 illustrates an example of an endpoint in a network generating a custom communication protocol; and

FIG. 6 illustrates an example simplified procedure for securing data communications with generative protocols.

### DESCRIPTION OF EXAMPLE IMPLEMENTATIONS

### Overview

According to one or more implementations of the disclosure, a device receives a request to generate a new communication protocol. The device generates, based on the request, the new communication protocol using a generative model. The device configures software to use the new communication protocol. The device causes an endpoint in a network to communicate using the new communication protocol via the software.

### Description

A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

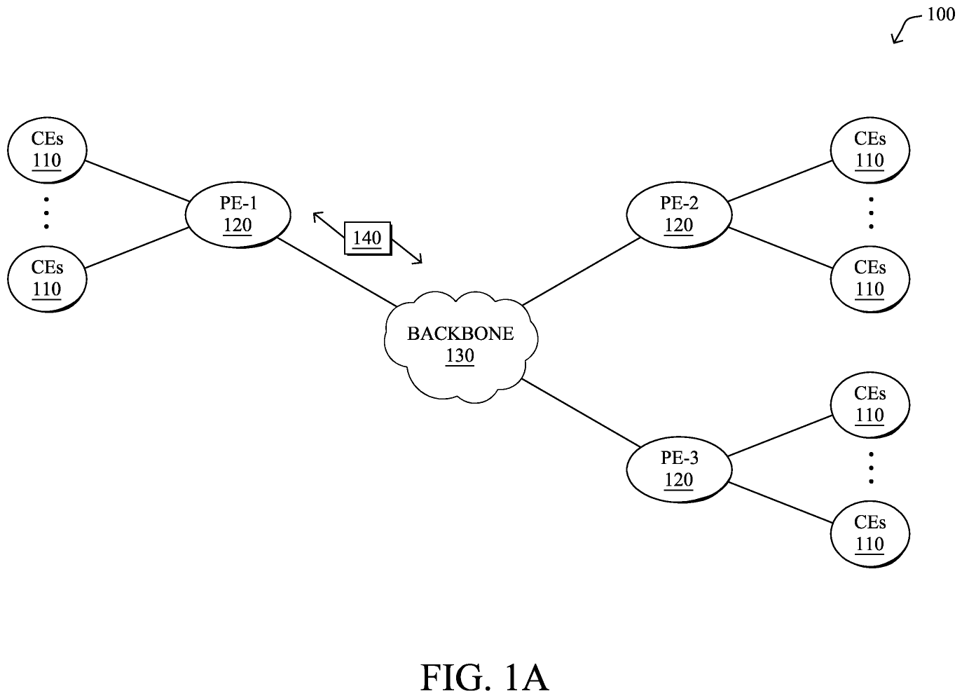

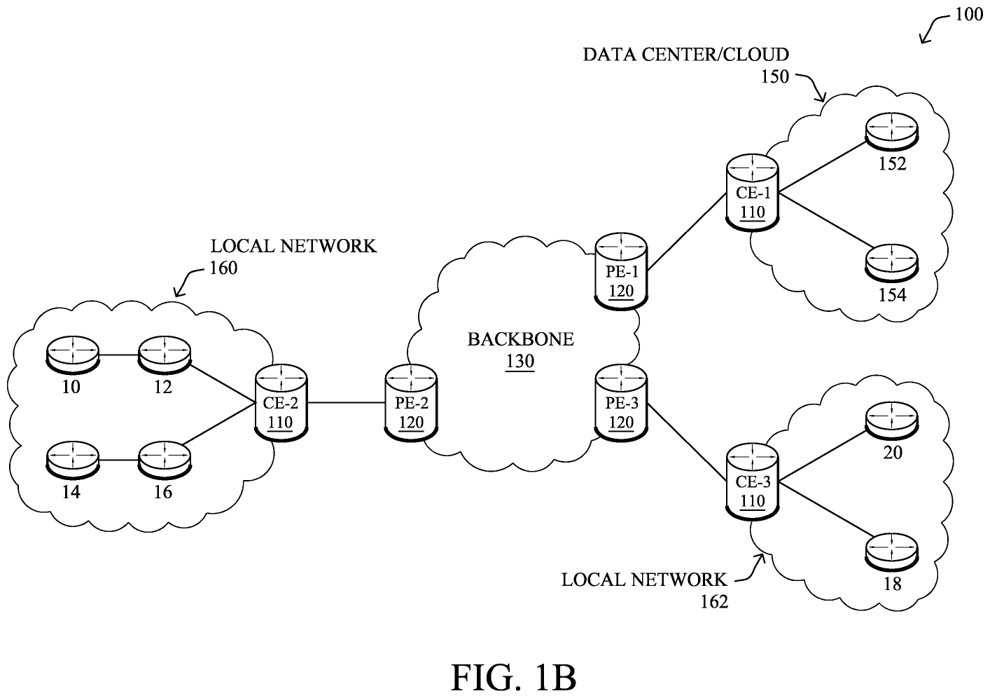

FIG. 1A is a schematic block diagram of an example computer network 100 illustratively comprising nodes/devices, such as a plurality of routers/devices interconnected by links or networks, as shown. For example, customer edge (CE) routers 110 may be interconnected with provider edge (PE) routers 120 (e.g., PE-1, PE-2, and PE-3) in order to communicate across a core network, such as an illustrative network backbone 130. For example, routers 110, 120 may be interconnected by the public Internet, a multiprotocol label switching (MPLS) virtual private network (VPN), or the like. Data packets 140 (e.g., traffic/messages) may be exchanged among the nodes/devices of the computer network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN thanks to a carrier network, via one or more links exhibiting very different network and service level agreement characteristics. For the sake of illustration, a given customer site may fall under any of the following categories:
1.) Site Type A: a site connected to the network (e.g., via a private or VPN link) using a single CE router and a single link, with potentially a backup link (e.g., a 3G/4G/5G/LTE backup connection). For example, a particular CE router 110 shown in network 100 may support a given customer site, potentially also with a backup link, such as a wireless connection.
2.) Site Type B: a site connected to the network by the CE router via two primary links (e.g., from different Service Providers), with potentially a backup link (e.g., a 3G/4G/5G/LTE connection). A site of type B may itself be of different types:
2a.) Site Type B1: a site connected to the network using two MPLS VPN links (e.g., from different Service Providers), with potentially a backup link (e.g., a 3G/4G/5G/LTE connection).
2b.) Site Type B2: a site connected to the network using one MPLS VPN link and one link connected to the public Internet, with potentially a backup link (e.g., a 3G/4G/5G/LTE connection). For example, a particular customer site may be connected to network 100 via PE-3 and via a separate Internet connection, potentially also with a wireless backup link.
2c.) Site Type B3: a site connected to the network using two links connected to the public Internet, with potentially a backup link (e.g., a 3G/4G/5G/LTE connection). Notably, MPLS VPN links are usually tied to a committed service level agreement, whereas Internet links may either have no service level agreement at all or a loose service level agreement (e.g., a “Gold Package” Internet service connection that guarantees a certain level of performance to a customer site).
3.) Site Type C: a site of type B (e.g., types B1, B2 or B3) but with more than one CE router (e.g., a first CE router connected to one link while a second CE router is connected to the other link), and potentially a backup link (e.g., a wireless 3G/4G/5G/LTE backup link). For example, a particular customer site may include a first CE router 110 connected to PE-2 and a second CE router 110 connected to PE-3.

FIG. 1B illustrates an example of network 100 in greater detail, according to various implementations. As shown, network backbone 130 may provide connectivity between devices located in different geographical areas and/or different types of local networks. For example, network 100 may comprise local/branch networks 160, 162 that include devices/nodes 10-16 and devices/nodes 18-20, respectively, as well as a data center/cloud environment 150 that includes servers 152-154. Notably, local networks 160-162 and data center/cloud environment 150 may be located in different geographic locations.

Servers 152-154 may include, in various implementations, a network management server (NMS), a dynamic host configuration protocol (DHCP) server, a constrained application protocol (CoAP) server, an outage management system (OMS), an application policy infrastructure controller (APIC), an application server, etc. As would be appreciated, network 100 may include any number of local networks, data centers, cloud environments, devices/nodes, servers, etc.

In some implementations, the techniques herein may be applied to other network topologies and configurations. For example, the techniques herein may be applied to peering points with high-speed links, data centers, etc.

According to various implementations, a software-defined WAN (SD-WAN) may be used in network 100 to connect local network 160, local network 162, and data center/cloud environment 150. In general, an SD-WAN uses a software defined networking (SDN)-based approach to instantiate tunnels on top of the physical network and control routing decisions, accordingly. For example, as noted above, one tunnel may connect router CE-2 at the edge of local network 160 to router CE-1 at the edge of data center/cloud environment 150 over an MPLS or Internet-based service provider network in backbone 130. Similarly, a second tunnel may also connect these routers over a 4G/5G/LTE cellular service provider network. SD-WAN techniques allow the WAN functions to be virtualized, essentially forming a virtual connection between local network 160 and data center/cloud environment 150 on top of the various underlying connections. Another feature of SD-WAN is centralized management by a supervisory service that can monitor and adjust the various connections, as needed.

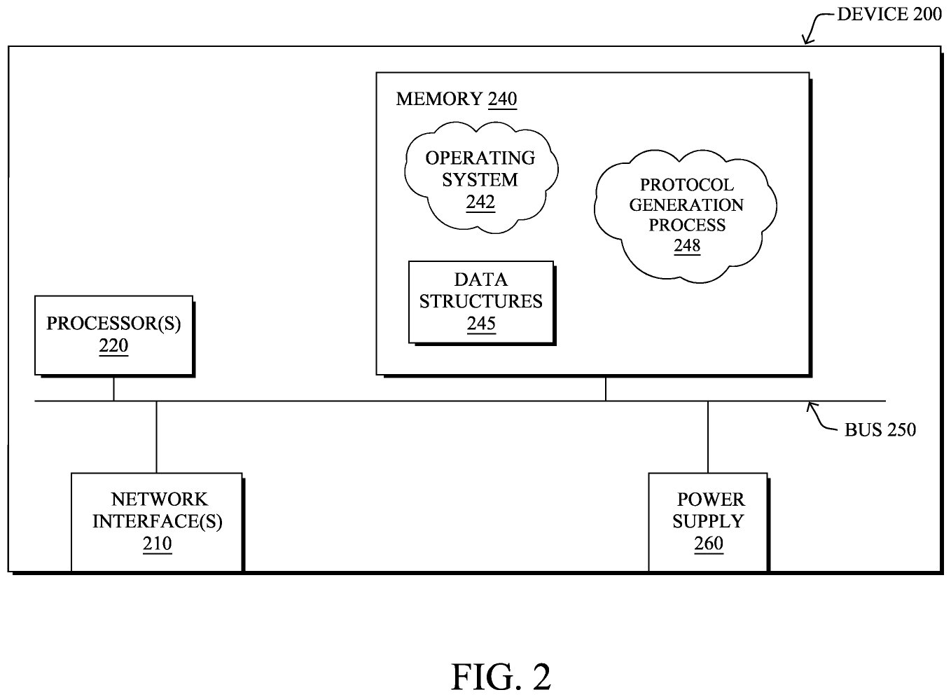

FIG. 2 is a schematic block diagram of an example node/device 200 (e.g., an apparatus) that may be used with one or more implementations described herein, e.g., as any of the computing devices shown in FIGS. 1A-1B, particularly the PE routers 120, CE routers 110, nodes/device 10-20, servers 152-154 (e.g., a network controller/supervisory service located in a data center, etc.), any other computing device that supports the operations of network 100 (e.g., switches, etc.), or any of the other devices referenced below. The device 200 may also be any other suitable type of device depending upon the type of network architecture in place, such as IoT nodes, etc. Device 200 comprises one or more network interfaces 210, one or more processors 220, and a memory 240 interconnected by a system bus 250, and is powered by a power supply 260.

The network interfaces 210 include the mechanical, electrical, and signaling circuitry for communicating data over physical links coupled to the network 100. The network interfaces may be configured to transmit and/or receive data using a variety of different communication protocols. Notably, a physical network interface 210 may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the implementations described herein. The processor 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software components may comprise a protocol generation process 248 as described herein, any of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

In various implementations, as detailed further below, protocol generation process 248 may include computer executable instructions that, when executed by processor(s) 220, cause device 200 to perform the techniques described herein. To do so, in some implementations, protocol generation process 248 may utilize machine learning. In general, machine learning is concerned with the design and the development of techniques that take as input empirical data (such as network statistics and performance indicators), and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a,b,c such that the number of misclassified points is minimal. After this optimization phase (or learning phase), the model M can be used very easily to classify new data points. Often, M is a statistical model, and the cost function is inversely proportional to the likelihood of M, given the input data.

In various implementations, protocol generation process 248 may employ one or more supervised, unsupervised, or semi-supervised machine learning models. Generally, supervised learning entails the use of a training set of data, as noted above, that is used to train the model to apply labels to the input data. For example, the training data may include sample telemetry that has been labeled as being indicative of an acceptable performance or unacceptable performance. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that protocol generation process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), generative adversarial networks (GANs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further implementations, protocol generation process 248 may also include one or more generative artificial intelligence (AI)/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. For instance, in the context of network assurance, process 248 may use a generative model to generate synthetic network traffic based on existing user traffic to test how the network reacts. Example generative approaches can include, but are not limited to, generative adversarial networks (GANs), large language models (LLMs), other transformer models, and the like.

The performance of a machine learning model can be evaluated in a number of ways based on the number of true positives, false positives, true negatives, and/or false negatives of the model. For example, consider the case of a model that predicts whether the QoS of a path will satisfy the service level agreement (SLA) of the traffic on that path. In such a case, the false positives of the model may refer to the number of times the model incorrectly predicted that the QoS of a particular network path will not satisfy the SLA of the traffic on that path. Conversely, the false negatives of the model may refer to the number of times the model incorrectly predicted that the QoS of the path would be acceptable. True negatives and positives may refer to the number of times the model correctly predicted acceptable path performance or an SLA violation, respectively. Related to these measurements are the concepts of recall and precision. Generally, recall refers to the ratio of true positives to the sum of true positives and false negatives, which quantifies the sensitivity of the model. Similarly, precision refers to the ratio of true positives the sum of true and false positives.

As noted above, entities wishing to compromise data communications between parties are, to some extent, helped by the use of data communications protocols that are based on published standards. In essence, published standards provide an ‘information foothold’ that a malicious entity could leverage.

To harden the solution and reduce the attack surface, military and government secure-grade communications systems, which are often classified or proprietary, employ advanced encryption techniques and strong authentication methods. While the encryption algorithms themselves may be classified, the keys used for encryption and decryption are normally managed through strict security protocols and regimes. The specific implementations used in such systems are not typically available to the general public, effectively denying an attacker the informational advantage. Hence, these security schemes increase security by reducing the known parts of the system, but still employ standard network protocols at their base.

The public availability of these protocol standards enables malicious entities to methodically listen to network traffic, while being able to even ‘make out’ any structure and predictability. This allows them to potentially analyze existing network traffic and gain insights into the communication protocols, data formats, and encryption methods used, offering starting points for an attacker to explore and exploit. For instance, the Internet today is premised on the use of the IPV4 (or IPv6) protocol as its foundation. Commonly used protocols to then secure communications across the Internet include Secure Sockets Layer (SSL), Transport Layer Security (TLS), and Internet Protocol Security (IPsec), among others.

Further security risks can also stem from the use of older protocol standards that did not consider newer attack methods, as well as flaws in standards implementations that create weaknesses that can be exploited. The impact can be significant when flaws are identified in commonly used secure communications methods, potentially affecting every user and device on the Internet.

### Securing Data Communications with Generative Protocols

The techniques introduced herein remove the information foothold offered by published communication standards by: a.) creating custom protocols that are only used by the designated endpoints and b.) allowing the system to change the entire communication protocol being used by the designated endpoints over time. This contrasts with common encryption mechanisms where the algorithm remains the same, but only the cryptographic key is changed.

Illustratively, the techniques described herein may be performed by hardware, software, and/or firmware, such as in accordance with protocol generation process 248, which may include computer executable instructions executed by the processor 220 (or independent processor of interfaces 210) to perform functions relating to the techniques described herein.

Specifically, according to various implementations, a device receives a request to generate a new communication protocol. The device generates, based on the request, the new communication protocol using a generative model. The device configures software to use the new communication protocol. The device causes an endpoint in a network to communicate using the new communication protocol via the software.

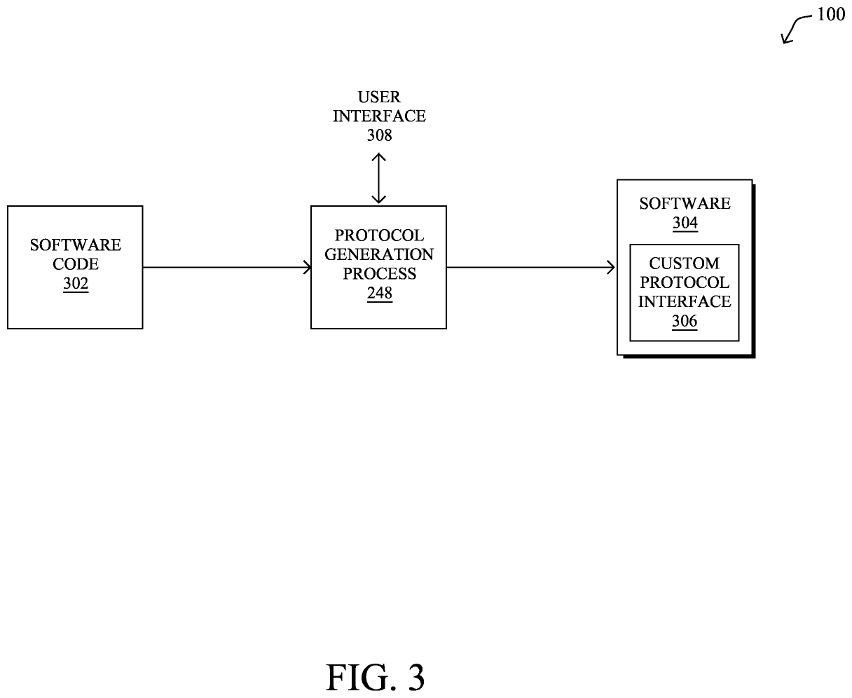

Operationally, FIG. 3 illustrates an example architecture 300 for securing data communications with generative protocols, in various implementations. At the core of architecture 300 is protocol generation process 248, which may be executed by any device in a computer network (e.g., a device 200), such as a server, edge device, end device, networking device, or the like. In some cases, protocol generation process 248 may also be executed in a distributed manner across multiple devices, in which case the collection of executing devices can be viewed as a singular device for purposes of the teachings herein.

During execution, protocol generation process 248 may interact with a user interface 308 operated by an administrator, security expert, or other interested party. Such a user interface may allow that user to request that a particular set of software code 302 be configured to use a custom communication protocol generated by protocol generation process 248. Protocol generation process 248 may also provide information to user interface 308 regarding the status of the system, such as the current version of communication protocol generated by protocol generation process 248, the version(s) being used by software in the network, or the like.

In various implementations, protocol generation process 248 may include a generative AI/machine learning model configured to generate a custom communication protocol. To do so, the model may be trained using a training dataset of protocol standards, other protocol documentation, etc. For instance, in some implementations, the model may take the form of a large language model (LLM) or other language model.

As would be appreciated, a communication protocol may include various elements such as any or all of the following:
A handshake mechanism that endpoints use to establish a secure connection over a network.
Various format parameters such as header fields of various sizes that convey information such as the encryption cipher suite to be used, a session identifier, padding, etc.
Etc.

Accordingly, in various implementations, the generative model of protocol generation process 248 may vary any or all of the above, to generate a custom communication protocol. For instance, different custom communication protocols generated by protocol generation process 248 may use different header fields, different header field sizes, different cipher suites, different handshake exchanges, etc. In one implementation, the generative model of protocol generation process 248 may even generate a new encryption protocol for use by the endpoints. In a further implementation, protocol generation process 248 may also track the configurations of the communication protocols that it generates over time, so as to ensure that each protocol that it generates uses a new format that was not previously generated.

As shown, another function of protocol generation process 248 may be to configure software code 302 selected by the user of user interface 308 to communicate via a computer network using the communication protocol generated by protocol generation process 248. The result of this is software 304, which may take the form of an operating system, network device driver, software application, combinations thereof, or the like, which includes a custom protocol interface 306 that allows software 304 to use the custom protocol generated by protocol generation process 248.

In some instances, software code 302 may take the form of programming code, in which case protocol generation process 248 may generate corresponding programming code for custom protocol interface 306 and insert it into software code 302. In turn, protocol generation process 248 may compile the resulting code or otherwise package it for execution or interpretation by any number of endpoints in a network (e.g., any terminal device in a communication path in the network). In other cases, software code 302 may take the form of an existing application, operating system, driver, or the like, in which case protocol generation process 248 may simply configure it to use custom protocol interface 306.

Regardless, once protocol generation process 248 has generated software 304 with custom protocol interface 306, software 304 may then be deployed to the target endpoints that are to communicate using the custom communication protocol. In some instances, this may be done using architecture 300, such as by deploying copies of software 304 via a computer network to any number of endpoints selected by user interface 308 (e.g., over a secure link). In other instances, though, software 304 could also be installed manually by a technician to the target endpoints.

Over time, architecture 300 may also update software 304 to use an updated custom communication protocol, as well. Doing so creates a “moving target” effect that would also make it even more difficult for malicious entities to gain an information foothold. For instance, architecture 300 may be configured to update the protocol and software 304, accordingly, on a periodic basis, in response to a request from user interface 308 to do so, or at any other such time.

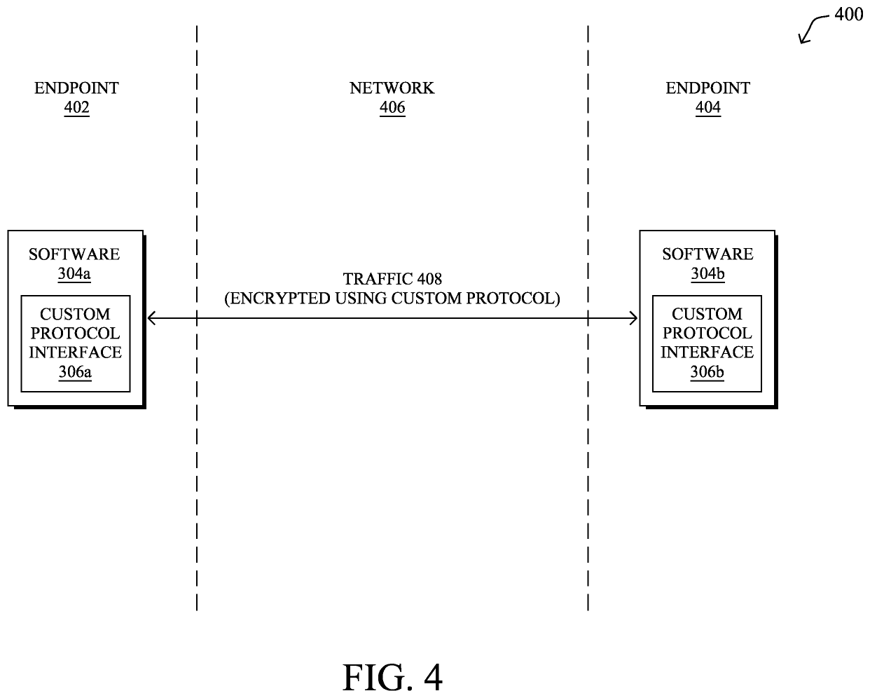

FIG. 4 illustrates an example 400 of endpoints in a network communicating using a custom communication protocol, in various implementations. As shown, assume now that copies of software 304 from FIG. 3 have been deployed to an endpoint 402 and an endpoint 404 connected by a computer network 406. More specifically, endpoint 402 may execute software 304a having custom protocol interface 306a and endpoint 404 may execute software 304b having custom protocol interface 306b.

A key functionality of custom protocol interface 306a and custom protocol interface 306b is to convert ‘clear-text’ data into traffic 408 that is encrypted using the custom communication protocol generated by protocol generation process 248 and send it to the remote endpoint via computer network 406. In turn, the receiving endpoint may use its corresponding protocol interface of its software to decrypt the encrypted traffic 408 for further processing. Since traffic 408 uses the custom communication protocol and not one that conforms to a published standard, any interception of the encrypted traffic by a malicious entity will be that much more difficult to decrypt.

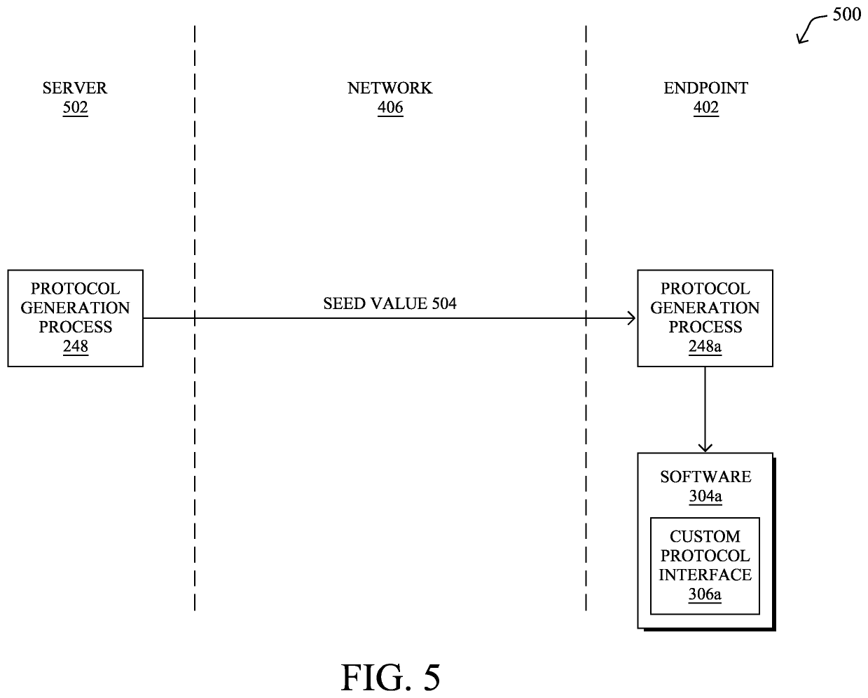

In further implementations, an alternate approach to centrally generating a new, custom communication protocol and software that supports it is shown in example 500 in FIG. 5. As shown, assume that a server 502 or other supervisory device in network 406 oversees the operations of any number of endpoints, such as endpoint 402. Rather than centrally generating and distributing copies of software 304 that are configured to use a custom communication protocol, copies of protocol generation process 248 may instead be distributed to the endpoints.

In turn, when the system is to update the communication protocol used between the endpoints, server 502 may send a seed value 504 over a secure channel to the copies of protocol generation process 248 on each of the target endpoints. In response, each of those copies may perform similar functions as that in FIG. 3, by configuring the local software 304 to communicate with a generated, custom communication protocol. For instance, in the case of endpoint 402, a request from server 502 that includes seed value 504 may cause protocol generation process 248a (i.e., the local copy of protocol generation process 248 on endpoint 402) to generate a custom communication protocol and configure software 304a with custom protocol interface 306a, accordingly.

A key feature of seed value 504 is that it may be configured to ensure that each of the local copies of protocol generation process 248 on the endpoints all generate the same communication protocol and configure their software 304 to use that protocol. This allows each of the target endpoints to begin using the new protocol when communicating with one another via 406.

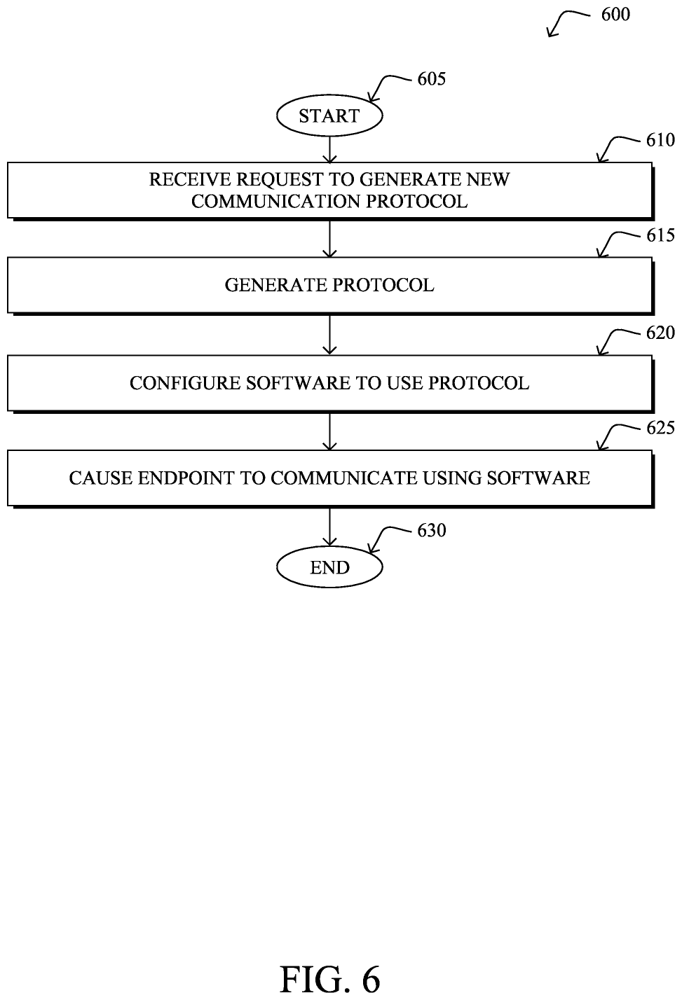

FIG. 6 illustrates an example simplified procedure 600 (e.g., a method) for securing data communications with generative protocols, in accordance with one or more implementations described herein. For example, a non-generic, specifically configured device (e.g., device 200), such as a router, firewall, controller for a network, server, or the like, may perform procedure 600 by executing stored instructions (e.g., protocol generation process 248). The procedure 600 may start at step 605, and continues to step 610, where, as described in greater detail above, the device may receive a request to generate a new communication protocol. In some implementations, the device receives the request from a user interface.

At step 615, as detailed above, the device may generate, based on the request, the new communication protocol using a generative model. In some implementations, the generative model is configured to generate a new format for the new communication protocol that it had not generated previously. In further implementations, the request includes a seed value that the generative model uses to generate the new communication protocol. In some implementations, the generative model comprises a large language model (LLM).

At step 620, the device may configure software to use the new communication protocol, as described in greater detail above. In various implementations, the software comprises an operating system, a device driver, or an application. In some implementations, the new communication protocol encrypts communications sent by the software via the network and decrypts communications received by the software via the network.

At step 625, as detailed above, the device may cause an endpoint in a network to communicate using the new communication protocol via the software. In one implementation, the device is the endpoint in the network. In other implementations, the device may distribute the software to the endpoint. In various implementations, the endpoint communicates with a second endpoint in the network using the new communication protocol and the second endpoint executes a copy of the software to communicate using the new communication protocol.

Procedure 600 then ends at step 630.

It should be noted that within the procedure 600, there is the potential for the new communications protocols to be applied on a per-communications link basis, on a per-network device basis, on a per-end-node basis or any combination of these aforementioned options. The range of options increases the potential set of communications protocols in use at any one point in time, increasing the complexity for the malicious actor and reducing the informational leverage that they may have been able to obtain.

It should be noted that while certain steps within procedure 600 may be optional as described above, the steps shown in FIG. 6 are merely examples for illustration, and certain other steps may be included or excluded as desired. Further, while a particular order of the steps is shown, this ordering is merely illustrative, and any suitable arrangement of the steps may be utilized without departing from the scope of the implementations herein.

While there have been shown and described illustrative implementations that provide for securing data communications with generative protocols, it is to be understood that various other adaptations and modifications may be made within the spirit and scope of the implementations herein. In addition, while certain protocols are shown, other suitable protocols may be used, accordingly.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof.

Accordingly, this description is to be taken only by way of example and not to otherwise limit the scope of the implementations herein. Therefore, it is the object of the appended claims to cover all such variations and modifications as come within the true spirit and scope of the implementations herein.

1. A method comprising:
receiving, at a device, a request to generate a new communication protocol;
generating, by the device and based on the request, the new communication protocol using a generative model;
configuring, by the device, software to use the new communication protocol; and
causing, by the device, an endpoint in a network to communicate using the new communication protocol via the software.

2. The method as in claim 1, wherein the device receives the request from a user interface.

3. The method as in claim 1, wherein the software comprises an operating system, a device driver, or an application.

4. The method as in claim 1, wherein the generative model is configured to generate a new format for the new communication protocol that it had not generated previously.

5. The method as in claim 1, wherein the request includes a seed value that the generative model uses to generate the new communication protocol.

6. The method as in claim 5, wherein the device is the endpoint in the network.

7. The method as in claim 1, wherein the new communication protocol encrypts communications sent by the software via the network and decrypts communications received by the software via the network.

8. The method as in claim 1, wherein causing the endpoint in the network to communicate using the new communication protocol via the software comprises:
distributing the software to the endpoint.

9. The method as in claim 1, wherein the generative model comprises a large language model (LLM).

10. The method as in claim 1, wherein the endpoint communicates with a second endpoint in the network using the new communication protocol, and wherein the second endpoint executes a copy of the software to communicate using the new communication protocol.

11. An apparatus, comprising:
one or more network interfaces;
a processor coupled to the one or more network interfaces and configured to execute one or more processes; and
a memory configured to store a process that is executable by the processor, the process when executed configured to:
receive a request to generate a new communication protocol;
generate, based on the request, the new communication protocol using a generative model;
configure software to use the new communication protocol; and
cause an endpoint in a network to communicate using the new communication protocol via the software.

12. The apparatus as in claim 11, wherein the apparatus receives the request from a user interface.

13. The apparatus as in claim 11, wherein the software comprises an operating system, a device driver, or an application.

14. The apparatus as in claim 11, wherein the generative model is configured to generate a new format for the new communication protocol that it had not generated previously.

15. The apparatus as in claim 11, wherein the request includes a seed value that the generative model uses to generate the new communication protocol.

16. The apparatus as in claim 15, wherein the apparatus is the endpoint in the network.

17. The apparatus as in claim 11, wherein the new communication protocol encrypts communications sent by the software via the network and decrypts communications received by the software via the network.

18. The apparatus as in claim 11, wherein the apparatus causes the endpoint in the network to communicate using the new communication protocol via the software by:
distributing the software to the endpoint.

19. The apparatus as in claim 11, wherein the generative model comprises a large language model (LLM).

20. A tangible, non-transitory, computer-readable medium storing program instructions that cause a device to execute a process comprising:
receiving, at the device, a request to generate a new communication protocol;
generating, by the device and based on the request, the new communication protocol using a generative model;
configuring, by the device, software to use the new communication protocol; and
causing, by the device, an endpoint in a network to communicate using the new communication protocol via the software.
